(19) United States
(12) Patent Application Publication
(10) Pub. No.: US 2014/0035241 A1
(43) Pub. Date: Feb. 6, 2014

(54) WORKHOLDING APPARATUS

(71) Applicant: Thomas A. Borysiak, Traverse City, MI (US)

(72) Inventor: Thomas A. Borysiak, Traverse City, MI (US)

(73) Assignee: ILLINOIS TOOL WORKS INC., Glenview, IL (US)

(21) Appl. No.: 13/565,064

(22) Filed: Aug. 2, 2012

(51) Int. Cl. B23B 31/34; B23B 31/02

(52) U.S. Cl. 279/132; 279/152

(57) ABSTRACT

A chuck assembly includes a chuck base configured to interface with a spindle of a machine tool, a cartridge including a receiving opening for receiving a workpiece to be worked using the machine tool, and clamping jaws disposed proximate to a working end of the chuck base to hold the cartridge therebetween. The cartridge further comprises a multi-axis clamping and locating assembly that simultaneously positions the workpiece and clamps the workpiece responsive to insertion of the workpiece into the receiving opening such that at least a portion of the workpiece that is to be worked via the machine tool is aligned with an axis of rotation of the chuck assembly.

### TECHNICAL FIELD

Example embodiments generally relate to machine tools and, more particularly, relate to a workholding apparatus of a machine tool that locates and clamps a workpiece at the same time and/or utilizes interchangeable cartridges to provide clamping and locating of parts of different sizes.

### BACKGROUND

Machine tools are commonly employed for shaping or machining of parts made from rigid materials such as metal. In its basic form, the machine tool includes a rotating spindle that is configured to hold a workpiece in place while the spindle turns about a fixed axis. A tool for shaping or machining the rotating workpiece is then enabled to contact the workpiece as the workpiece is turned. A chuck may be employed to hold the workpiece in place while the spindle rotates. In some cases, the chuck may employ jaws, teeth or other mechanisms to clamp the workpiece in place so that the workpiece can be maintained fixed relative to the axis of rotation. Hydraulic pressure or other such mechanisms may be employed for clamping.

In many situations, it may be desirable to achieve a relatively high rotational speed of the spindle while machining or cutting a workpiece. For a workpiece that has a relatively symmetric shape about a rotational axis, chuck design may be relatively simple. However, when a workpiece has an unusual shape, it may be difficult to design a chuck that is capable of holding the portion of the workpiece that is to be machined in a fixed orientation relative to the axis of rotation. Furthermore, having to accommodate workpieces of different sizes may further complicate matters.

### BRIEF SUMMARY OF SOME EXAMPLES

Some example embodiments may provide a workholding apparatus for use with a machine tool that can make it easier to deal with irregular shaped workpieces. In this regard, for example, some embodiments may provide a chuck that locates, clamps and compensates a workpiece at the same time. Thus, when the workpiece is clamped in place, it can be assured that the workpiece is located properly for rotation such that the portion of the workpiece that is to be machined is properly oriented relative to the axis of rotation of the chuck. Some embodiments may also or alternatively provide a chuck that includes interchangeable cartridges to provide clamping and locating of parts of different sizes simply by removing a cartridge that accommodates one size of part and replacing it with a cartridge that accommodates a different size of part.

In one example embodiment, a chuck assembly is provided. The chuck assembly may include a chuck base configured to interface with a spindle of a machine tool, a cartridge including a receiving opening for receiving a workpiece to be worked using the machine tool, and clamping jaws disposed proximate to a working end of the chuck base to hold the cartridge therebetween. The cartridge further comprises a multi-axis clamping and locating assembly that simultaneously positions the workpiece and clamps the workpiece responsive to insertion of the workpiece into the receiving opening such that at least a portion of the workpiece that is to be worked via the machine tool is aligned with an axis of rotation of the chuck assembly.

In another example embodiment, cartridge for a chuck assembly that is configured to interface with a spindle of a machine tool is provided. The cartridge may include a receiving opening for receiving a workpiece to be worked using the machine tool, and a multi-axis clamping and locating assembly. The multi-axis clamping and locating assembly may be configured to simultaneously position the workpiece and clamp the workpiece responsive to insertion of the workpiece into the receiving opening such that at least a portion of the workpiece that is to be worked via the machine tool is aligned with an axis of rotation of the chuck assembly.

In another example embodiment, a chuck assembly is provided. The chuck assembly may include a chuck base configured to interface with a spindle of a machine tool, a mounting pad disposed on the chuck base to receive a selected one of a plurality of interchangeable cartridges, a counterweight disposed at the mounting pad proximate to the selected one of the plurality of interchangeable cartridges to balance the chuck assembly and clamping jaws disposed proximate to a working end of the chuck base to hold the selected one of the plurality of interchangeable cartridges therebetween. The selected one of the plurality of interchangeable cartridges includes a receiving opening dimensioned for receiving a workpiece to be worked using the machine tool. Each different one of the plurality of interchangeable cartridges has a corresponding differently dimensioned receiving opening.

Some example embodiments may improve the performance of machine tools and, in particular, may make conversion of the machine tool for use with different workpieces a simpler and more cost effective operation by providing interchangeable cartridges for use with machine tool chucks that employ an example embodiment.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a chuck assembly according to an example embodiment;

FIG. 2 illustrates a perspective view of the chuck assembly with a workpiece inserted into a receiving opening of the chuck assembly according to an example embodiment;

FIG. 3 illustrates a cross sectional view of the chuck assembly along a line extending through a centerline dividing the clamping jaws symmetrically according to an example embodiment;

FIG. 4 illustrates a cross sectional view of the chuck assembly along a line extending through a centerline dividing the receiving opening symmetrically according to an example embodiment;

FIG. 5 is a top view of the chuck assembly according to an example embodiment; and

FIG. 6, which includes FIGS. 6A and 6B, shows a view of an example workpiece (FIG. 6A) and a view of a normalization area of the workpiece (FIG. 6B) according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may improve the ability of operators to make relatively quick and easy adjustments to a machine tool chuck in order to make the chuck accommodate workpieces of different sizes (or shapes). In this regard, for example, rather than requiring major equipment modifications such as complete replacement of a chuck, a relatively simple adjustment involving the replacement of an interchangeable cartridge of the chuck may be provided in order to accommodate workpieces of different sizes. Furthermore, in some cases, each of the interchangeable cartridges may be designed such that they are configured to handle both clamping and locating of the workpiece within the chuck at the same time. In other words, placement of the workpiece into the cartridge for holding simultaneously accomplishes both proper location and clamping of the workpiece such that by virtue of placing the workpiece properly within the receiving space of the cartridge the workpiece will also be clamped in place. Accordingly, machine tool down time may be reduced when changing the tool over from one size (or type) of workpiece to another size (or type) of workpiece.

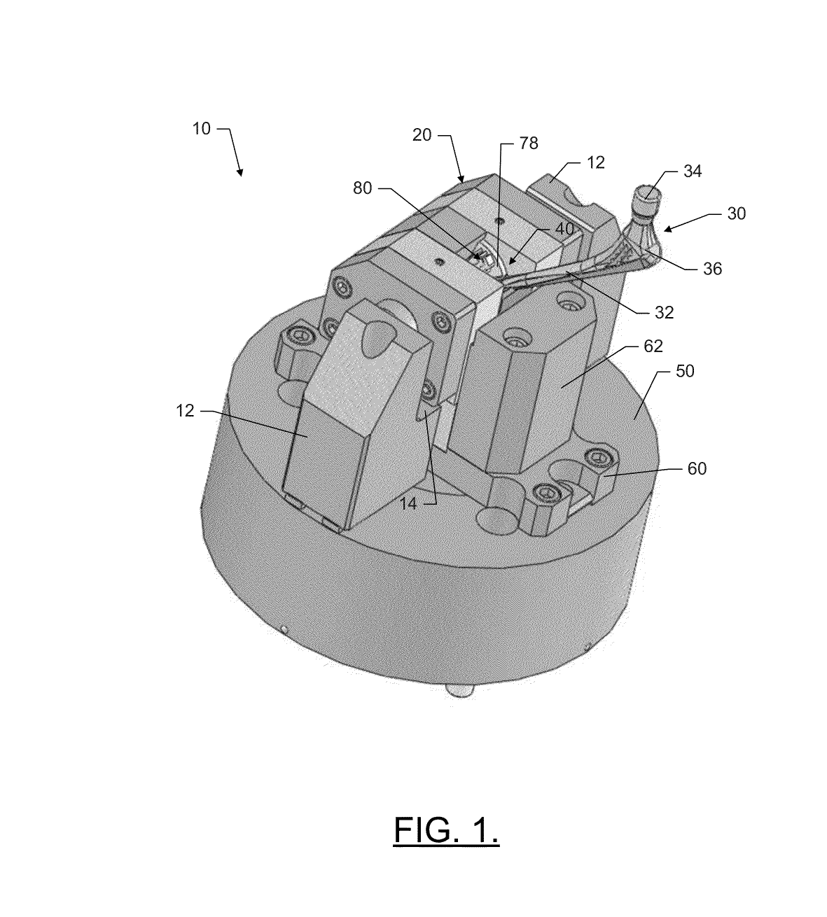

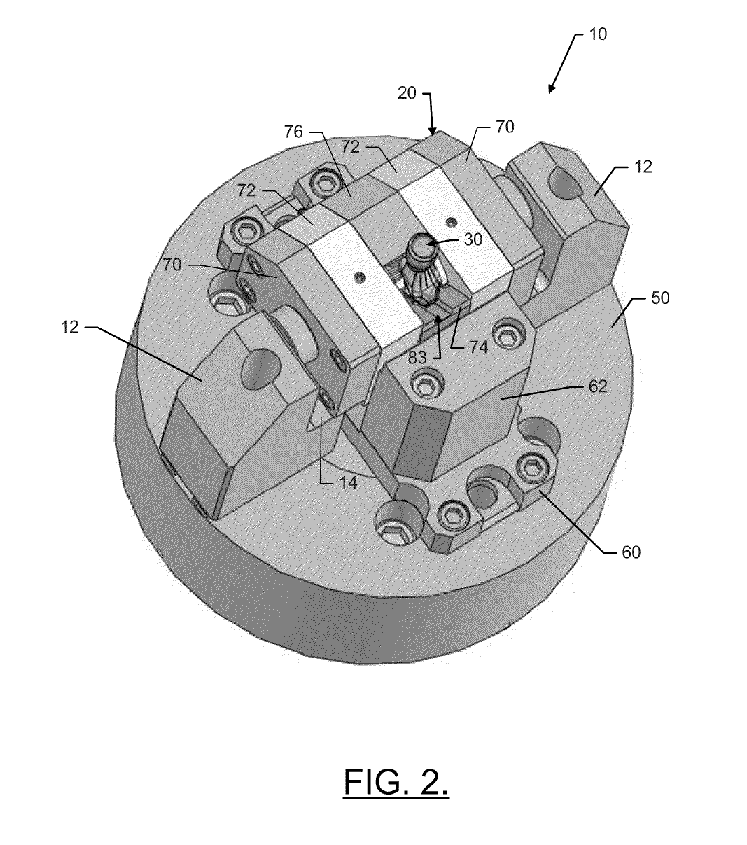

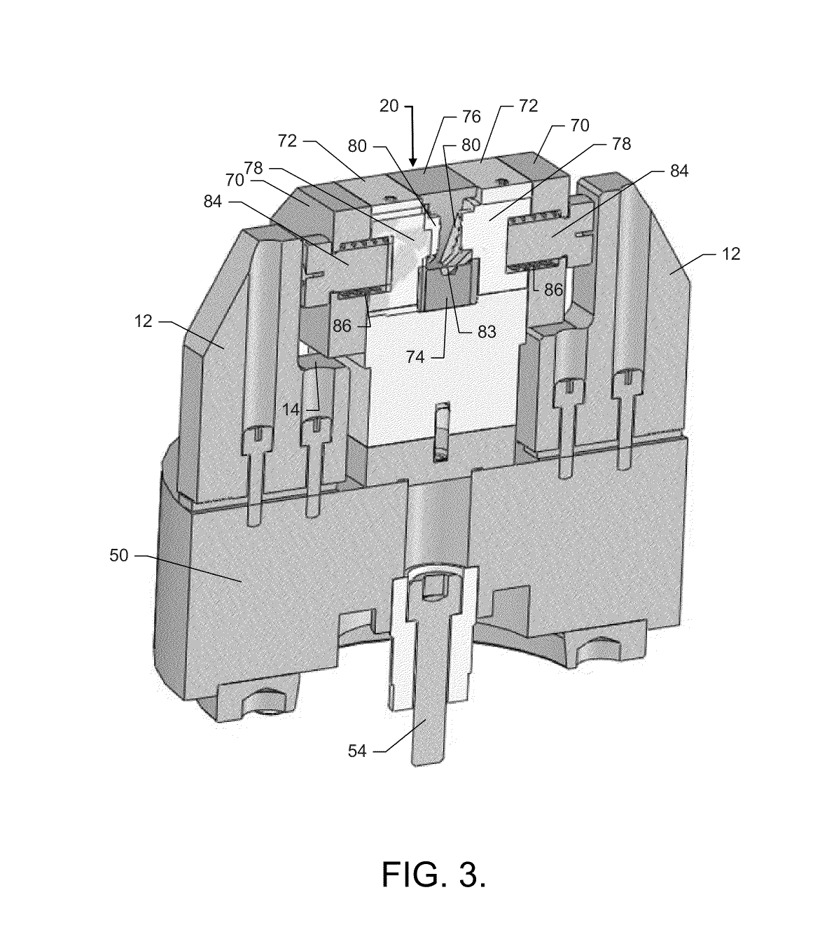

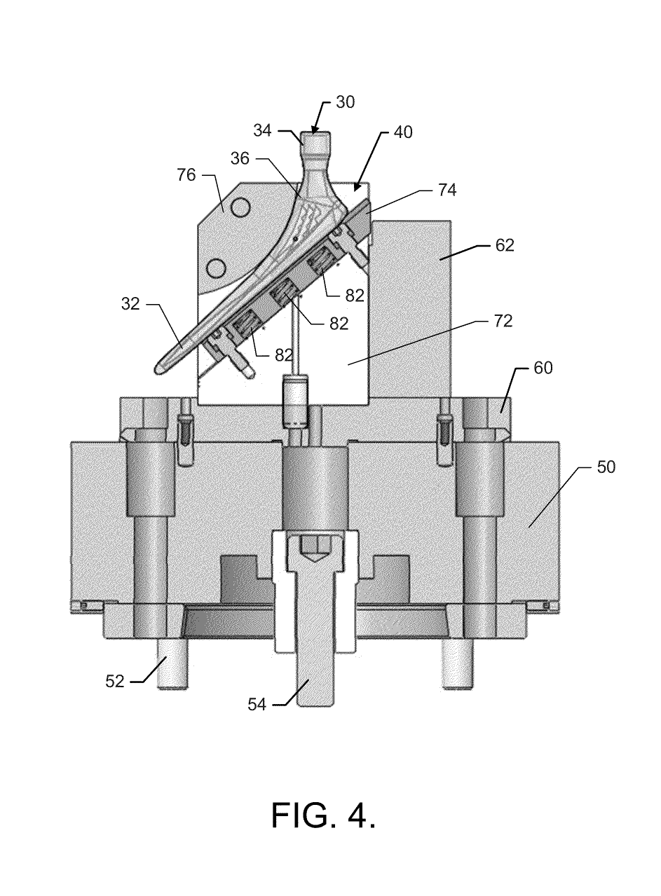

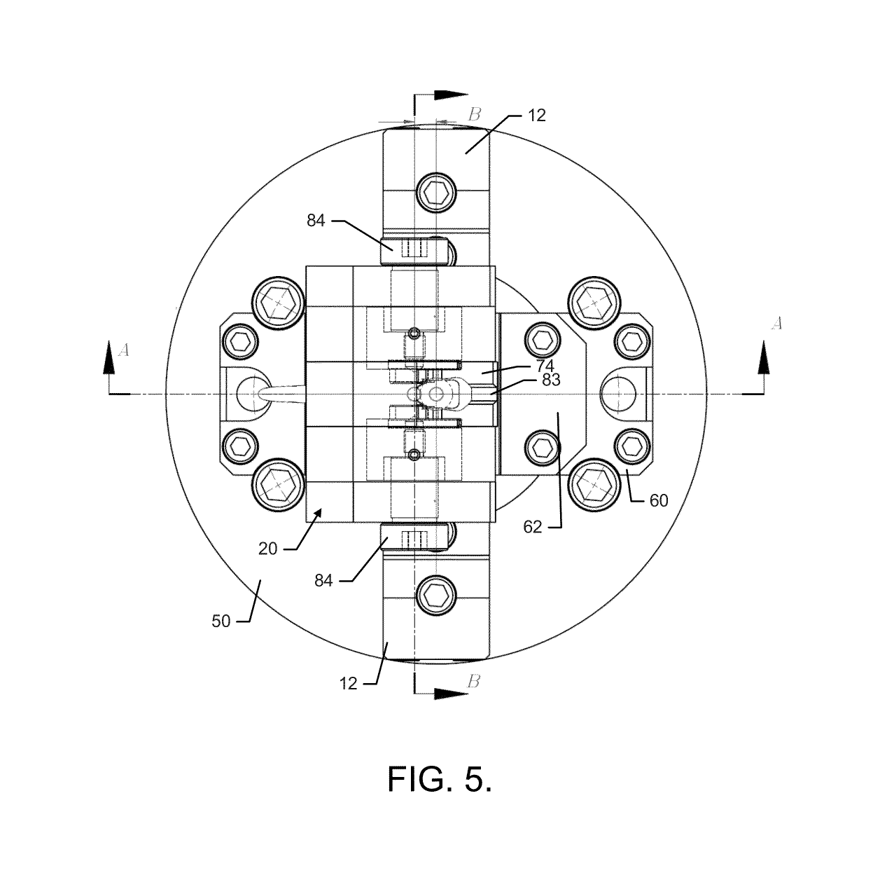

FIG. 1 illustrates a perspective view of a chuck assembly 10 according to an example embodiment. The chuck assembly 10 includes clamping jaws 12 that are disposed to oppose each other on opposite sides of a cartridge 20 that is configured to position and hold a workpiece 30. FIG. 1 shows the workpiece 30 prepared for insertion into the chuck assembly 10. FIG. 2 illustrates a perspective view of the chuck assembly 10 with the workpiece 30 inserted into a receiving opening 40 of the chuck assembly 10 according to an example embodiment. FIG. 3 illustrates a cross sectional view of the chuck assembly 10 along a line extending through a centerline dividing the clamping jaws 12 symmetrically according to an example embodiment. FIG. 4 illustrates a cross sectional view of the chuck assembly 10 along a line extending through a centerline dividing the receiving opening 40 symmetrically according to an example embodiment. FIG. 5 is a top view of the chuck assembly 10 according to an example embodiment. It should be appreciated that the chuck assembly 10 may be attached to a spindle of a machine tool by any method known in the art. The chuck assembly 10 may then be enabled to rotate with the spindle about an axis defined substantially at the longitudinal axis of the chuck assembly 10.

Referring now to FIGS. 1-5, the chuck assembly 10 may include a chuck base 50. The chuck base 50 may substantially cylindrical in shape. In some embodiments, the chuck base 50 may include a spindle adapter 52 and a drawbolt 54 that may work together to enable the chuck base 50 to be affixed to a spindle of a machine tool. The drawbolt 54 may be disposed substantially along an axis of rotation of the chuck base 50 when the chuck assembly 10 is rotated with the spindle.

In an example embodiment, a top surface of the chuck base 50 (i.e., a working end of the chuck base 50) may be substantially flat to facilitate engagement of the chuck base 50 to other components of the chuck assembly 10. In this regard, for example, the working end of the chuck base 50 may be affixed to a mounting plate 60. The mounting plate 60 may be bolted, welded or otherwise affixed to the chuck base 50 such that it extends transversely over the top surface of the chuck base 50. A longitudinal centerline of the mounting plate 60 may be aligned with a plane that divides the chuck base 50 into symmetrical halves while passing through the rotational axis of the chuck assembly 10.

In some embodiments, the chuck assembly 10 may include a counterweight 62 that may be attached to the mounting plate 60 at one longitudinal end thereof. In an example embodiment, the counterweight 62 may be bolted, welded or otherwise affixed to the mounting plate 60. The counterweight 62 may be configured to have a size and weight to compensate for the weight of the cartridge 20. Accordingly, when the chuck assembly 10 is rotated about the axis of rotation, the chuck assembly 10 may be balanced and rotate about the axis without an eccentricity condition.

In an example embodiment, the clamping jaws 12 may be operably coupled to the chuck base 50 facing each other proximate to opposite lateral sides of the mounting plate 60. The clamping jaws 12 may each include a seat portion 14 that extends inwardly toward the mounting plate 60 and defines a seating surface that lies substantially parallel to the top face of the chuck base 50. In an example embodiment, a bottom of outer portions of opposite sides of the cartridge 20 may be proximate to or otherwise sit on the seat portion 14.

The clamping jaws 12 may be enabled to move at least to some degree inwardly responsive to an external pressure being applied (e.g., hydraulic pressure). Accordingly, for example, when the cartridge 20 is installed in the chuck assembly 10 between the clamping jaws 12 and proximate to the counterweight 62, the clamping jaws 12 may be closed via the external pressure being applied thereto and the clamping jaws 12 may clamp the cartridge 20 in place. In some cases, the clamping force may also be applied at least in part to the workpiece 30, as will be described in greater detail below.

The cartridge 20 may include two cover/guide plates 70 that are disposed at opposite lateral ends of the cartridge 20. The cover/guide plates 70 may be formed of two substantially rectangular plates that are configured to be placed proximate to the clamping jaws 12 when the cartridge 20 is inserted onto the mounting plate 60. Of note, any suitable shape may be employed for the cover/guide plates 70 and thus, it is not necessary that they be embodied as substantially rectangular shaped plates. The cover/guide plates 70 may be positioned proximate to a housing 72 that may form an interior structure of the cartridge 20 that at least in part defines the receiving opening 40. In this regard, for example, the housing 72 may surround a guide pad 74 and a part stop 76 that form bottom and top walls for the receiving opening 40, respectively. As such, the guide pad 74. The part stop 76 and sidewalls of the housing 72 may define the receiving opening 40 into which the workpiece 30 is engageable. Thus, for example, the guide pad 74 and part stop 76 may face each other on opposite sides of the receiving opening 40 and the guide pad 74 and part stop 76 may be sandwiched between sidewalls of the housing 72. The sidewalls of the housing 72 may then be sandwiched between the cover/guide plates 70. In some cases, the guide pad 74 may also sit atop a portion of the housing 72 that contacts the mounting plate 60. The cover/guide plates 70, the housing 72, the guide pad 74 and/or the part stop 76 may be affixed to each other via bolts or any other desirable attachment method.

In an example embodiment, the cartridge 20 may be an interchangeable part. As such, for example, various different cartridges may be substituted for the cartridge 20 and each one may be specifically tailored to holding a different workpiece. In the pictured examples, the cartridge 20 is suitable for use with the workpiece 30. However, if a larger or smaller workpiece is to be machined, or if a different shaped workpiece is to be machined, a corresponding different cartridge may be used to replace the cartridge 20 shown in FIGS. 1-5. In some embodiments, the general dimensions of replacement cartridges may be the same as the general dimensions of the cartridge 20 (i.e., same length, width, height, weight, and/or the like). However, the size and structure of the receiving opening 40 may be altered in replacement cartridges so that the replacement cartridges have receiving openings and structural components associated therewith that are tailored specifically to the workpiece to be held thereby.

The workpiece 30 of an example embodiment may be a hip stem for an artificial hip. Accordingly, for example, the workpiece 30 may have a relatively irregular shape. In this regard, the workpiece 30 may include a femoral stem 32 that is configured to interface with the femur of a patient and a head 34 that is configured to interface with the socket portion of the hip joint of the patient. The workpiece 30 may further include a normalization area 36 disposed to transition between the femoral stem 32 and the head 34.

Machining of the head 34 may be desired prior to insertion of a ball onto the head 34 or to shape the head 34 to form a ball to fit within the socket portion of the hip joint of the patient. As can be seen from FIGS. 1 and 2, the head 34 may be substantially cylindrical in shape. To machine the head 34, it is desirable to fix an axial center of the head 34 inline with the axis of rotation of the chuck assembly 10. However, since the workpiece 30 has an irregular shape, holding the head 34 such that the axial center of the head 34 is inline with the axis of rotation of the chuck assembly 10 may be difficult with a conventional chuck. In this regard, for example, a conventional chuck may require that the workpiece 30 be initially located properly so that it is aligned with the axis of rotation of the chuck. However, when clamping is accomplished thereafter, the workpiece 30 may often be moved from the aligned location. Even a slight movement may cause problems at high speeds of rotation, so it is highly desirable to ensure that the workpiece 30 can be clamped accurately in alignment with the axis of rotation.

Some embodiments of the present invention may therefore deal with this potential problem by accomplishing location (i.e., proper alignment or positioning) of the workpiece 30 simultaneous with the operation of clamping. Accordingly, by virtue of properly locating or positioning the workpiece 30 within the chuck assembly 10, the workpiece 30 will also be clamped in the proper location. To accomplish locating and clamping of the workpiece 30 simultaneously, some example embodiments may include a multi-axis clamping and locating assembly configured to provide for proper alignment of the workpiece 30 as the workpiece 30 is inserted into the receiving opening 40 and also provide a force on the workpiece 30 to hold the workpiece 30 in the proper alignment. As such, the multi-axis clamping and locating assembly may be disposed proximate to or otherwise define edges of the receiving opening 40.

In an example embodiment, top and bottom limits of the receiving opening 40 may be defined by the guide pad 74 and the part stop 76, respectively, as described above. The sidewalls of the housing 72 may also at least partially define the receiving opening 40. However, some example embodiments may employ horizontal locating/clamping pads 78 that may be disposed within the sidewalls of the housing 72. The horizontal locating/clamping pads 78 may include locating lands 80 disposed on portions thereof that face the receiving opening 40. Accordingly, for example, one horizontal locating/clamping pad 78 may be disposed on each opposing side of the receiving opening 40 to form part of the multi-axis clamping and locating assembly (i.e., the horizontal component). Meanwhile, the guide pad 74 and the part stop 76 may form another part of the multi-axis clamping and locating assembly (i.e., the vertical component).

In some embodiments, both the vertical and horizontal components of the multi-axis clamping and locating assembly may include spring loaded structures to provide for clamping of the workpiece 30 as the workpiece is guided into its proper location within the receiving opening 40. In this regard, for example, as shown in FIG. 4, the guide pad 74 may have springs 82 disposed to exert a force pushing the guide pad 74 away from the housing 72 and toward the receiving opening 40. The rest position of the guide pad 74 may be configured such that the vertical size of the receiving opening 40 (e.g., the height) when the workpiece 30 is not inserted into the receiving opening 40 is less than the vertical height of the workpiece 30. Thus, as the workpiece 30 is inserted into the receiving opening 40, the spring force applied by the springs 82 may be overcome and the guide pad 74 may be urged in a direction away from the receiving opening to allow the workpiece 30 to fit between the guide pad 74 and the part stop 76 also allowing for compensation of part tolerancing. Furthermore, as is also shown in FIG. 4, the part stop 76 may be shaped such that its profile substantially matches that of the workpiece 30. As such, there is a natural fixed stopping point for insertion of the workpiece 30 into the receiving opening 40 when the upper portion of the normalization area 36 reaches a convex portion of the part stop 76. Thus, the head 34 may be moved to a relatively fixed location that is substantially in alignment with the axis of rotation of the chuck assembly 10 when the natural fixed stopping point is reached, and the pressure exerted on the workpiece 30 in the vertical direction by the springs 82 of the guide pad 74 will also increase until that point so that the workpiece 30 is both properly located and clamped at the same time in the vertical direction.

In some embodiments, the guide pad 74 may further include a guiding groove 83 disposed in a surface thereof. In this regard, for example, as shown in FIG. 2, the guiding groove 83 may be sized such that the width of the guiding groove 83 substantially matches the width of the femoral stem 32 and the normalization area 36 along one side (i.e., a bottom side) thereof. The guiding groove 83 may be provided to extend along a longitudinal centerline of the guide pad 74 to further assist in ensuring that the workpiece 30 is centered relative to the width of the receiving opening 40.

In the horizontal direction, the horizontal locating/clamping pad 78 on each side of the receiving opening 40 may also be biased inwardly under spring pressure. For example, the cartridge 20 may include a transfer pin 84 disposed on each distal end thereof. In an example embodiment, the transfer pin 84 on each end of the cartridge 20 may pass through the cover/guide plates 70 in order to contact the horizontal locating/clamping pad 78 on each respective side. As shown in FIG. 3, the transfer pin 84 on each end may be provided with a corresponding biasing spring 86 that is configured to push the horizontal locating/clamping pad 78 on its respective side toward the receiving opening 40. In an example embodiment, the biasing spring 86 on each side may have one distal end thereof disposed to press against a portion of the cover/guide plate 70, which is fixed, and the other distal end thereof to press against the horizontal locating/clamping pad 78, which is allowed to move at least to some degree within the housing 72 and toward the receiving opening 40. Moreover, the rest position of the horizontal locating/clamping pad 78 on each side of the receiving opening 40 may be configured such that the horizontal size of the receiving opening 40 (e.g., the width) when the workpiece 30 is not inserted into the receiving opening 40 is less than the horizontal width of the workpiece 30. Accordingly, when the workpiece 30 is inserted into the receiving opening 40, the biasing spring 86 on each side of the receiving opening 40 must be overcome.

The biasing springs 86 may be arranged to have substantially similar characteristics such that if one of the biasing springs 86 is more compressed than the other, the more compressed biasing spring 86 will exert a larger force on the workpiece 30. Thus, responsive to insertion of the workpiece 30 into the receiving opening 40, the biasing springs 86 exert mutually opposing forces that tend to compensate for varying part tolerances and cause the workpiece 30 to be centered therebetween while being clamped by the forces exerted by the biasing springs 86. Accordingly, the workpiece 30 is both centered relative to the horizontal dimension of the receiving opening 40 and clamped in place.

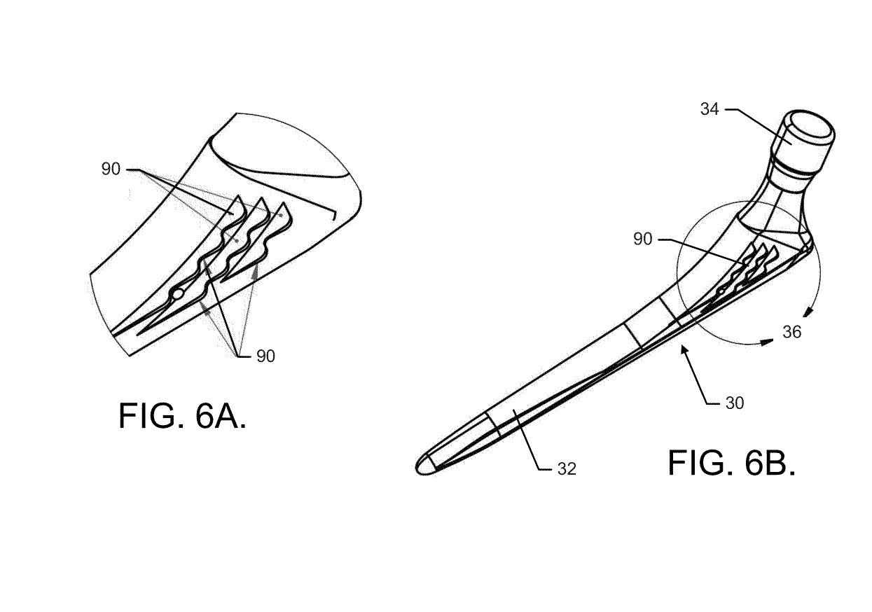

FIG. 6, which includes FIGS. 6A and 6B, shows a view of an example workpiece (FIG. 6A) and a view of a normalization area of the workpiece (FIG. 6B) according to an example embodiment. As shown in FIG. 6, the workpiece 30 may be provided with locating edges 90. The locating edges 90 may be disposed on opposite lateral sides of the normalization area 36. In an example embodiment, the locating edges may be a series of depressions or raised surfaces that have a shape that may be matched by corresponding raised surfaces or depressions, respectively, on the horizontal locating/clamping pads 78. In this regard, for example, the horizontal locating/clamping pads 78 may be provided with locating lands 80 disposed face the receiving opening 40. Although the locating lands 80 of FIGS. 1 and 3 are shown as protrusions shaped to match the depressions provided on the workpiece 30 in the form of the locating edges 90, it should be appreciated that the protrusions could alternatively be provided on the workpiece 30 and corresponding depressions could be provided on the horizontal locating/clamping pads 78.

In an example embodiment, insertion of the workpiece 30 into the receiving opening 40 may stop when the locating lands 80 engage the locating edges 90. Moreover, in some embodiments, an audible snapping sound and/or tactilely perceptible seating of the locating lands 80 with the locating edges 90 may be experienced by an operator inserting the workpiece 30 into the receiving opening 40 so that the operator can appreciate that the workpiece 30 is properly positioned in the receiving opening 40. Accordingly, the engagement of the locating lands 80 with the locating edges 90 may provide for proper alignment of the workpiece 30 relative to the axis of rotation of the chuck assembly 10 while simultaneously providing for clamping of the workpiece 30 under the spring force provided by the biasing springs 86.

Both horizontal and vertical locating and clamping of the workpiece 30 within the receiving opening 40 may therefore be accomplished simultaneously according to example embodiments. In some cases, the clamping provided under spring force will be sufficient to hold the workpiece 30 (or at least the head 34) aligned with the axis of rotation of the chuck assembly 10 when the chuck assembly 10 is not being rotated at high speed. However, it may be desirable to provide additional clamping force to hold the workpiece 30 in place for high speed operation. Thus, for example, the transfer pins 84 may be enabled to be operably coupled to the clamping jaws 12. In this regard, instead of having the clamping jaws 12 directly contact the cover/guide plates 70 of the cartridge 20, some embodiments may enable the clamping jaws 12 to exert a force directly onto the transfer pins 84 when external pressure is applied to the clamping jaws 12. The transfer pins 84 may then communicate the exerted force to the horizontal locating/clamping pads 78 so that the workpiece 30 may be held in place for high speed operation.

Some embodiments may therefore enable a workpiece that is irregularly shaped to be supported in a chuck assembly so that at least a portion of the workpiece that is to be worked (e.g., the head 34) is provided to be aligned with an axis of rotation of the chuck assembly. Moreover, the workpiece may be guided into a fixed position having the portion of the workpiece that is aligned with the axis of rotation in a manner that simultaneously locates and clamps the workpiece. The simultaneous locating and clamping may further be accomplished over multiple axes (e.g., horizontal and vertical axes). In some embodiments, the simultaneous location and clamping of the workpiece may be accomplished via an interchangeable cartridge that is usable with the chuck assembly. In this regard, for example, a plurality of different interchangeable cartridges may be useable with the chuck assembly and each different interchangeable cartridge may have different characteristics that correspond to respective different workpieces that may be desirable for working via operation of a machine tool that employs the chuck assembly. As an example, some embodiments may provide that the receiving opening of the cartridge is dimensioned to support a specific workpiece. The cartridge may then be replaceable with at least one other interchangeable cartridge having a differently dimensioned receiving opening to support a different workpiece.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A chuck assembly comprising:
a chuck base configured to interface with a spindle of a machine tool;
a cartridge including a receiving opening for receiving a workpiece to be worked using the machine tool; and
clamping jaws disposed proximate to a working end of the chuck base to hold the cartridge therebetween,
wherein the cartridge further comprises a multi-axis clamping and locating assembly that simultaneously positions the workpiece and clamps the workpiece responsive to insertion of the workpiece into the receiving opening such that at least a portion of the workpiece that is to be worked via the machine tool is aligned with an axis of rotation of the chuck assembly.

2. The chuck assembly of claim 1, wherein the receiving opening of the cartridge is dimensioned to support the workpiece, and the cartridge is replaceable with at least one other interchangeable cartridge having a differently dimensioned receiving opening to support a different workpiece.

3. The chuck assembly of claim 1, wherein the multi-axis clamping and locating assembly comprises a guide pad defining a first boundary of the receiving opening and a part stop disposed to face the guide pad on an opposing side of the receiving opening to define a second boundary of the receiving opening.

4. The chuck assembly of claim 3, wherein the guide pad and the part stop are disposed to define vertically oriented boundaries for the receiving opening.

5. The chuck assembly of claim 3, wherein the guide pad is biased toward the part stop via at least one spring.

6. The chuck assembly of claim 3, wherein the guide pad comprises a guiding groove disposed to extend along a longitudinal centerline of a surface of the guide pad, the guiding groove having a width substantially matching a width of a corresponding portion of the workpiece to center the workpiece relative to a width of the receiving opening.

7. The chuck assembly of claim 1, wherein the multi-axis clamping and locating assembly comprises a locating and clamping pad disposed on each opposing side of the receiving opening along a horizontal axis.

8. The chuck assembly of claim 7, wherein each locating and clamping pad is spring biased inwardly with respect to the receiving opening.

9. The chuck assembly of claim 7, wherein the cartridge further comprises a transfer pin on each opposing end thereof proximate to the clamping jaws, the transfer pins being operably coupled to respective ones of the locating and clamping pads,
wherein a biasing spring disposed proximate to the transfer pin applies spring forces on each locating and clamping pad to clamp the workpiece under biasing spring pressure responsive to insertion of the workpiece into the receiving opening, and
wherein the clamping jaws, responsive to application of an external pressure thereto, provide clamping of the workpiece via the transfer pin and the locating and clamping pads.

10. The chuck assembly of claim 1, wherein the workpiece comprises a hip stem for an artificial hip.

11. The chuck assembly of claim 10, wherein the workpiece comprises a femoral stem portion, a head and a normalization area provided between the femoral stem and the head.

12. The chuck assembly of claim 11, wherein the normalization area comprises locating edges disposed on opposite lateral sides of the normalization area, the locating edges comprising one or more depressions or raised surfaces that have a shape matched by corresponding raised surfaces or depressions, respectively, on locating and clamping pads disposed on each opposing side of the receiving opening along a horizontal axis thereof, the locating and clamping pads defining a horizontal portion of the multi-axis clamping and locating assembly.

13. The chuck assembly of claim 11, wherein the multi-axis clamping and locating assembly comprises a guide pad defining a first boundary of the receiving opening and a part stop disposed to face the guide pad on an opposing side of the receiving opening to define a second boundary of the receiving opening, and
wherein the normalization area is configured to engage the part stop in response to a rotational axis of the head being substantially aligned with the rotational axis of the chuck assembly.

14. A cartridge for a chuck assembly configured to interface with a spindle of a machine tool, the cartridge comprising:
a receiving opening for receiving a workpiece to be worked using the machine tool; and
a multi-axis clamping and locating assembly that simultaneously positions the workpiece and clamps the workpiece responsive to insertion of the workpiece into the receiving opening such that at least a portion of the workpiece that is to be worked via the machine tool is aligned with an axis of rotation of the chuck assembly.

15. The cartridge of claim 14, wherein the multi-axis clamping and locating assembly comprises a guide pad defining a first boundary of the receiving opening and a part stop disposed to face the guide pad on an opposing side of the receiving opening to define a second boundary of the receiving opening.

16. The cartridge of claim 15, wherein the guide pad and the part stop are disposed to define vertically oriented boundaries for the receiving opening, and wherein the guide pad is biased toward the part stop via at least one spring.

17. The cartridge of claim 15, wherein the guide pad comprises a guiding groove disposed to extend along a longitudinal centerline of a surface of the guide pad, the guiding groove having a width substantially matching a width of a corresponding portion of the workpiece to center the workpiece relative to a width of the receiving opening.

18. The cartridge of claim 14, wherein the multi-axis clamping and locating assembly comprises a locating and clamping pad disposed on each opposing side of the receiving opening along a horizontal axis, and wherein each locating and clamping pad is spring biased inwardly with respect to the receiving opening.

19. The cartridge of claim 18, wherein the cartridge further comprises a transfer pin on each opposing end thereof proximate to clamping jaws disposed at a chuck base of the chuck assembly, the transfer pins being operably coupled to respective ones of the locating and clamping pads,
wherein a biasing spring disposed proximate to the transfer pin applies spring forces on each locating and clamping pad to clamp the workpiece under biasing spring pressure responsive to insertion of the workpiece into the receiving opening, and
wherein the clamping jaws, responsive to application of an external pressure thereto, provide clamping of the workpiece via the transfer pin and the locating and clamping pads.

20. A chuck assembly comprising:
a chuck base configured to interface with a spindle of a machine tool;
a mounting pad disposed on the chuck base to receive a selected one of a plurality of interchangeable cartridges;
a counterweight disposed at the mounting pad proximate to the selected one of the plurality of interchangeable cartridges to balance the chuck assembly; and
clamping jaws disposed proximate to a working end of the chuck base to hold the selected one of the plurality of interchangeable cartridges therebetween,
wherein the selected one of the plurality of interchangeable cartridges includes a receiving opening dimensioned for receiving a workpiece to be worked using the machine tool, and wherein each different one of the plurality of interchangeable cartridges has a corresponding differently dimensioned receiving opening.
